(19) United States
(12) Patent Application Publication
(10) Pub. No.: US 2015/0292711 A1
(43) Pub. Date: Oct. 15, 2015

(54) LED Lights for Underwater Use

(71) Applicants: Mark Branson, Hinckley (GB); Henning von Spreckelsen, Cranleigh (GB); Paul Freedman, London (GB)

(72) Inventors: Mark Branson, Hinckley (GB); Henning von Spreckelsen, Cranleigh (GB); Paul Freedman, London (GB)

(21) Appl. No.: 14/682,647

(22) Filed: Apr. 9, 2015

(30) Foreign Application Priority Data
Apr. 11, 2014 (GB) 1406588.2

(51) Int. Cl. F21V 7/00; F21V 31/00; F21V 23/00

(52) U.S. Cl. CPC F21V 7/0091; F21V 23/005; F21V 31/005; F21W 2111/04

(57) ABSTRACT

A lighting unit (2) for marine or other underwater use has an array of LEDs (60, 62) mounted in groups (46) on a printed circuit board (6). A plastic injection moulded collimator is associated with a group of LEDs and a group of such collimators are provided in a single contiguous moulding which can also provide a cover (20) and means for mounting the lighting unit to a vessel and facilitates sealing of the unit.

### CROSS REFERENCE TO RELATED APPLICATION

This application claims priority to and the benefit of the filing date of Great Britain Patent Application No. 1406588.2, filed on Apr. 11, 2014, the entire disclosure of which is incorporated by reference herein.

### TECHNICAL FIELD

The present teachings relate to lighting units or luminaires for marine or other underwater use using LEDs as the light source or engine.

### BACKGROUND ART

Sealed light-emitting diode (LED) lighting units for mounting to the exterior hull of a yacht in order to project a beam of light into the surrounding sea are known and described, for example, in U.S. Patent Application Publication No. 2007/139913 by N. Savage.

When LEDs are used to create a light engine, a heat sink needs to be provided in order to dissipate heat generated. Savage proposed utilising the cooling effect of direct contact between the water in the housing to dissipate the heat generated by the LEDs in use.

LED light engines also can require collimators in order to direct the light from an LED array into a single beam of light.

The lighting unit must also be capable of sealing to prevent ingress of water. Even small amounts of water ingress create condensation problems inside the unit and affect its optical properties. It has been proposed, for example, in U.S. Patent Application Publication No. 2011/267834 by Potucek et al., to use an optically transparent potting compound to encapsulate the light emitting element and/or the electronic assembly. The use of such a potting compound prolongs manufacturing times due to the need for curing.

Lighting units that provide for tuneable colour temperature by the provision of a group of LEDs have been described, for example, in U.S. Patent Application Publication No. 2008/231214 by Kim et al. However, such tuneable arrangements have not been made available for marine lighting.

It has been proposed in International Publication No. WO 2004/031649 A1 by applicant, Truck-Lite Co., Inc., in the context of LED vehicle lights that are not suitable for underwater use, to combine a lens with a cover for the unit. However, in that design in order to produce a collimated beam, Truck-Lite proposes a separate reflector in conjunction with a convex lens. The design also takes into account that the light passes from the cover into air not water.

### SUMMARY

A lighting unit in accordance with the present teachings is defined in the claims.

The design of the collimator should take into account that one face of the optical structures will be submerged in liquid rather than air reducing the effect of refraction at this boundary. The present teachings seek to improve on prior art designs where each LED can be provided with its own collimator based on surrounding parabolic reflector.

The use of a one-piece injection moulded polymer unit to provide a sealing cover and optical collimation can simplify the manufacturing process and permit the provision of colour tuneable lighting units.

### BRIEF DESCRIPTION OF DRAWINGS

In order that the present teachings may be well understood, an embodiment thereof will now be described by way of example only, with reference to the accompanying diagrammatic drawings, in which:

FIG. 1 shows a plan view of a lighting unit in accordance with the present teachings;

FIG. 2 is a vertical section on the line G-G in FIG. 1;

FIG. 3 is a detail view looking into a collimator for an LED group;

FIG. 4 shows a diagrammatic plan view illustrating the arrangement of LEDs in the embodiment of FIGS. 1 to 3; and

FIG. 5 shows an alternative configuration with larger groups of LEDs.

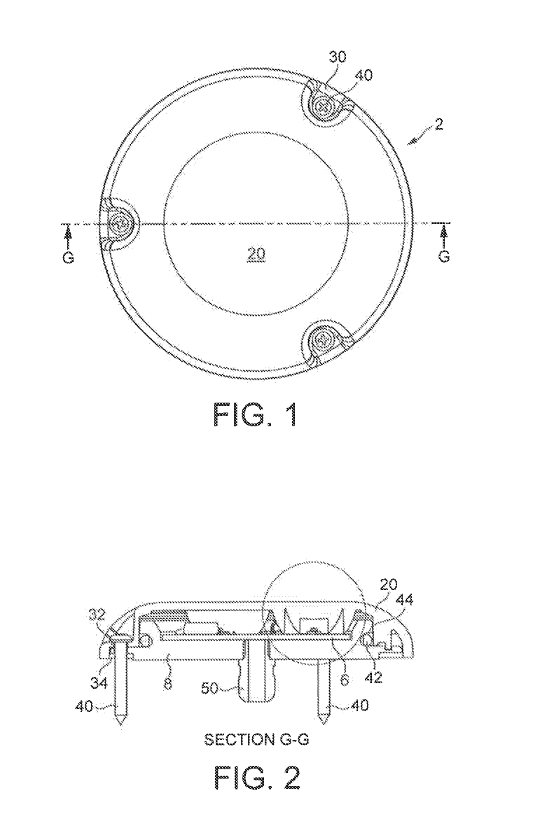

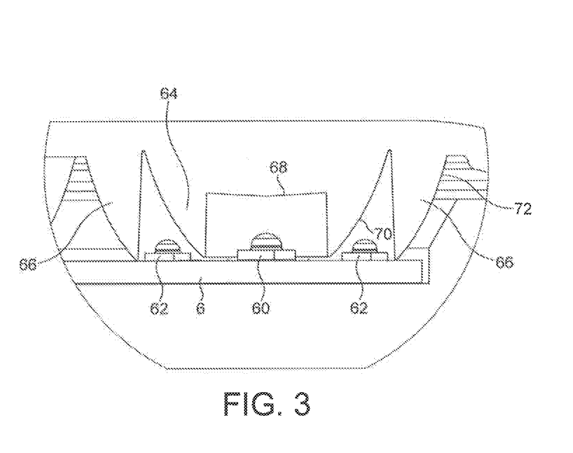

### DETAILED DESCRIPTION

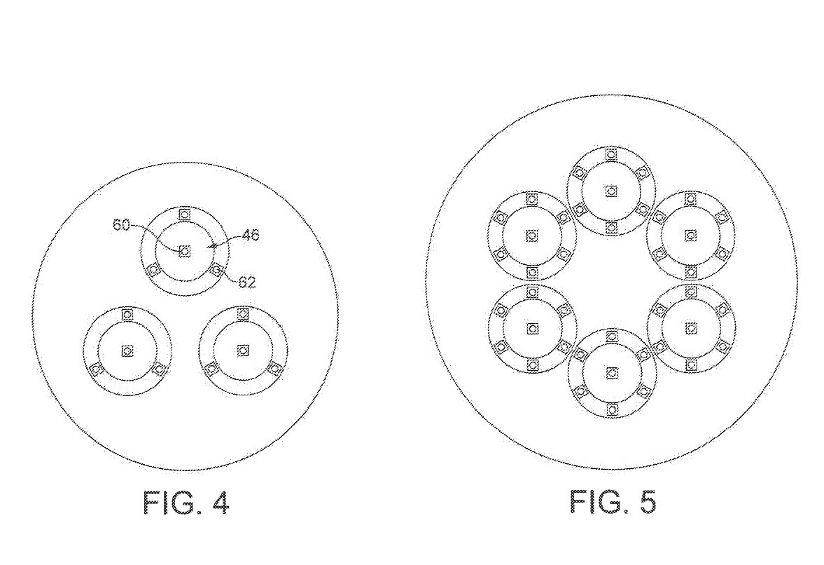

A lighting unit 2 for marine or other underwater use has an array of LEDs 4 mounted on a circuit board 6. The unit is made up of a base member 8 which can be a metal casting or polymer moulding. The base member 8 supports a printed circuit board 10 on which the LEDs 4 are mounted. The LEDs are preferably mounted in groups as shown in FIG. 4 but single LEDs may be used with the surrounding LEDs of the illustrated groups not present in order to produce a more economical unit.

A plastic injection moulded cover 20 is a single one-piece moulding that defines a cover for the unit and also provides integral primary and secondary collimators associated with each group of LEDs. The group collimators are provided in a single contiguous moulding. The cover has an external face for direct contact with water and an internal face shaped to sealingly engage with the base member with the PCB therebetween. The internal face defines a respective recess which sits over each LED to provide a coaxial collimator for that LED using total internal reflection. Accordingly the cover houses the LEDs within recesses that capture substantially all the emitted light rays so that space inside the unit is minimised. It will be appreciated that the cover provides all the necessary optical processing and there is no need for any independent reflectors as in Truck-Lite. The outer surface or external face of the cover is designed to be in direct contact with water and the optics are designed taking into account the refraction at that transition. The cover also provides means for mounting the lighting unit to a vessel and facilitates sealing of the unit.

The cover 20 has recessed mounting points 30 which have openings 32 that align with corresponding openings 34 at the periphery of the base member 8. These openings permit screws 40 to pass through both cover 20 and base member 8 in order to allow the unit to be secured to a vessel or underwater wall, preferably in thermal contact with the adjacent wall if it is conductive.

The base member 8 and cover are clamped sealingly together sandwiching the PCB 6 therebetween. An O-ring seal 42 is received in a surrounding groove 44 of the base member 8 in order to provide a watertight seal between the base member and the adjacent formations on the cover.

The base member 8 has a central opening into which a sleeve 50 is fitted in order to provide for the passage of electrical connections to the circuit board 6. The base member serves to provide a thermal path for internally generated waste heat to be conducted to the wall surface to which the unit is mounted.

The circuit board 6 supports the LEDs mounted in groups 46. Each group has a primary LED light source 60 and is surrounded by three, or in an alternative embodiment shown in FIG. 5, six other LEDs 62 in an annular arrangement. As mentioned above the surrounding LEDs may not be fitted if the most economical design without colour tuneability is preferred. In order to provide for colour tuneability, the colour temperatures of the surrounding LEDs are selected or are controllable to produce the desired hue or colour temperature.

An internal surface of the cover 20 is shaped during the moulding process to provide a primary collimator 64 for the primary LED light source 60 and a coaxial secondary collimator 66 for the surrounding LED light sources 62. The primary collimator 64 defines a cylindrical recess 68 which sits over the primary LED 60. An external surface 70 of the primary collimator is provided with a parabolic shape in order to permit total internal reflection of low angle light rays emitted by the LED in order to produce a collimated beam in the water. A top surface of the recess 68 may also be appropriately shaped as a downward pointing flat cone in order to shape the light rays contacted by that surface. Those skilled in the art of optical design will appreciate that the precise profiles can be designed depending on the optical properties of the plastic and the liquid in which the lighting unit is to be submerged in order to produce abeam of the required shape in the water. This beam shape may be collimated into a columnar beam or may produce a flared beam shape depending on the style of illumination required.

The secondary collimator 66 is an annular ring surrounding the primary collimator in order to define an annular slot in which the secondary LEDs 62 are positioned in a spaced array. An external surface 72 of the secondary collimator ring 66 is shaped similarly to the surface 70 in order to refract light emerging at low angle from the secondary LED sources. Each group of LEDs is therefore mounted and emitting about a single optical axis.

The function of the primary and secondary collimators is to merge light from both the primary and secondary LEDs into a single beam. The colour temperature or colour hue of the beam can be tuned dynamically by appropriate control circuitry on the PCB 6 or set at the time of manufacture. It will be appreciated that the same set of components can be utilised to produce a variety of differing products depending on the characteristics of each group of LEDs.

The cover moulding 20 is made from a plastics polymer with an appropriate degree of optical clarity and refractive index in order to achieve the required collimation. Suitable polymers include acrylic glass or poly(methyl methacrylate) (PMMA), polyamide (PA), or polycarbonate (PC).

The proposed design of coaxial collimation significantly lowers the profile of the cover relative to prior art designs using multiple individual collimators or Fresnel lenses. This allows slimmer lighting units to be produced.

By utilising a single element for creating the lens system and providing the sealing barrier, the component count of the resulting unit is significantly reduced.

What is claimed is:

1. A lighting unit for underwater use comprising; a base member supporting at least one LED, and a single moulded cover having an external face for direct contact with water and an internal face shaped to sealingly engage with the base member with the PCB therebetween, the internal face defining a recess which sits over the LED to provide a coaxial collimator for the LED using total internal reflection.

2. A lighting unit as claimed in claim 1 wherein the PCB supports a plurality of LEDs arranged in at least one group.

3. A lighting unit as claimed in claim 2, wherein each LED group comprises a primary LED that is located centrally in a primary collimator having a profiled external surface and a plurality of secondary LEDs arranged around the primary LED and inside a coaxial secondary collimator.

4. A lighting unit for underwater use comprising a PCB supporting a plurality of LEDs arranged in at least one group; a base member and a single moulded cover shaped to sealingly engage with the base member with the PCB therebetween and define a recess which sits over the LEDs to provide coaxial collimators for each group of LEDs.
